(19) United States
(12) Patent Application Publication
(10) Pub. No.: US 2003/0057667 A1
(43) Pub. Date: Mar. 27, 2003

(54) Nose plate attachment for stackable open front grocery and goods bin

(76) Inventor: William Bernard Trescott, Sargent, TX (US)

Correspondence Address: WILLIAM B. TRESCOTT, 8028 FM 457 - SARGENT, BAY CITY, TX, 77414, US

(21) Appl. No.: 10/267,056

(22) Filed: Oct. 9, 2002

Related U.S. Application Data
(63) Continuation-in-part of application No. 09/901,303, filed on Jul. 10, 2001.

(51) Int. Cl. B62B 3/00

(52) U.S. Cl. 280/43

(57) ABSTRACT

The present invention is a fork lift attachment for lifting and carrying Stackable Open Front Grocery and Goods Bins with Air Cushion Mobility—lightweight, somewhat fragile produce containers, preferably made out of plastic, which are designed to float on a cushion of compressed air like a hovercraft. It can be equipped with wheels to function as a stand alone cart.

### BACKGROUND

1. Field of the Invention

The present invention pertains to the art of transporting goods—it is a type of carrying device that can be equipped with wheels and can also be attached to a fork lift truck.

2. Statement of the Problem

The Stackable Open Front Grocery and Goods Bin with Air Cushion Mobility (FIG. 2) is a light weight, somewhat fragile plastic produce container which is designed to float over smooth floors on a cushion of compressed air like a hovercraft. This method of transport can only be used within the proximity of a compressed air source (FIG. 3). The air cushion lip on the bottom of the bin (FIG. 5) is likely to be damaged if the bin is dragged across a rough surface. People who use material handling equipment such as fork lift trucks and pallet jacks would like to have a device which would allow their present material handling equipment to carry the new bins without damaging them (FIG. 4). Fork lift attachments which apply suction or clamping pressure or scrape underneath are likely to damage the thin sides or bottoms of these fragile containers.

### SUMMARY OF THE INVENTION

Solution to the Problem:

The present invention fits around the back of a stack of bins and supports the bottom bin by the bin's strong curled top edges so that the stack can be carried a great distance (FIG. 4). Fitted with wheels, the present invention can be used as a stand alone cart for carrying bins (FIG. 3). The present invention fits on the front of a fork lift truck when the forks are removed (FIG. 4). By tilting the fork lift truck's mast, the bins can be carried at an angle to prevent goods from falling out of the bins.

### BRIEF DESCRIPTION OF THE DRAWING

FIG. 1 Left front view of the present invention fitted with wheels and levers

FIG. 2 Left front view of the Stackable Open Front Grocery and Goods Bin

FIG. 3 Stackable Open Front Grocery and Goods Bins with air hoses attached

FIG. 4 The present invention and a stack of bins mounted on a fork lift truck

FIG. 5 Ventral view of Stackable Open Front Grocery Bin compressed air fitting

### DESCRIPTION OF THE PREFERRED EMBODIMENT

1. Overview

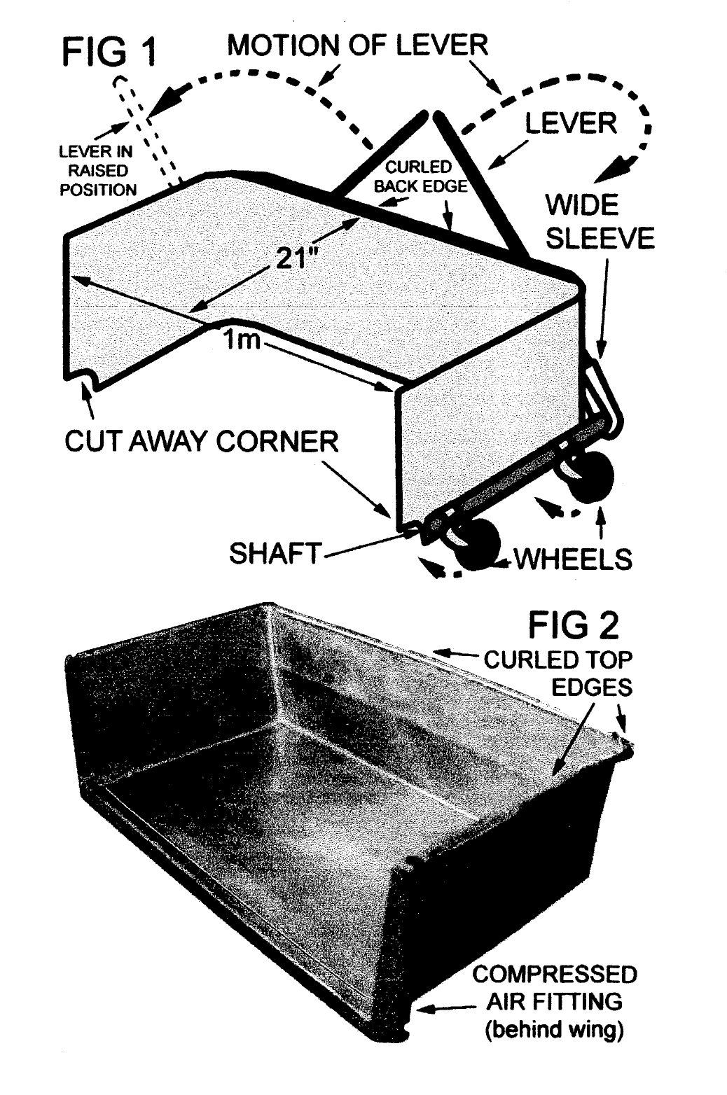

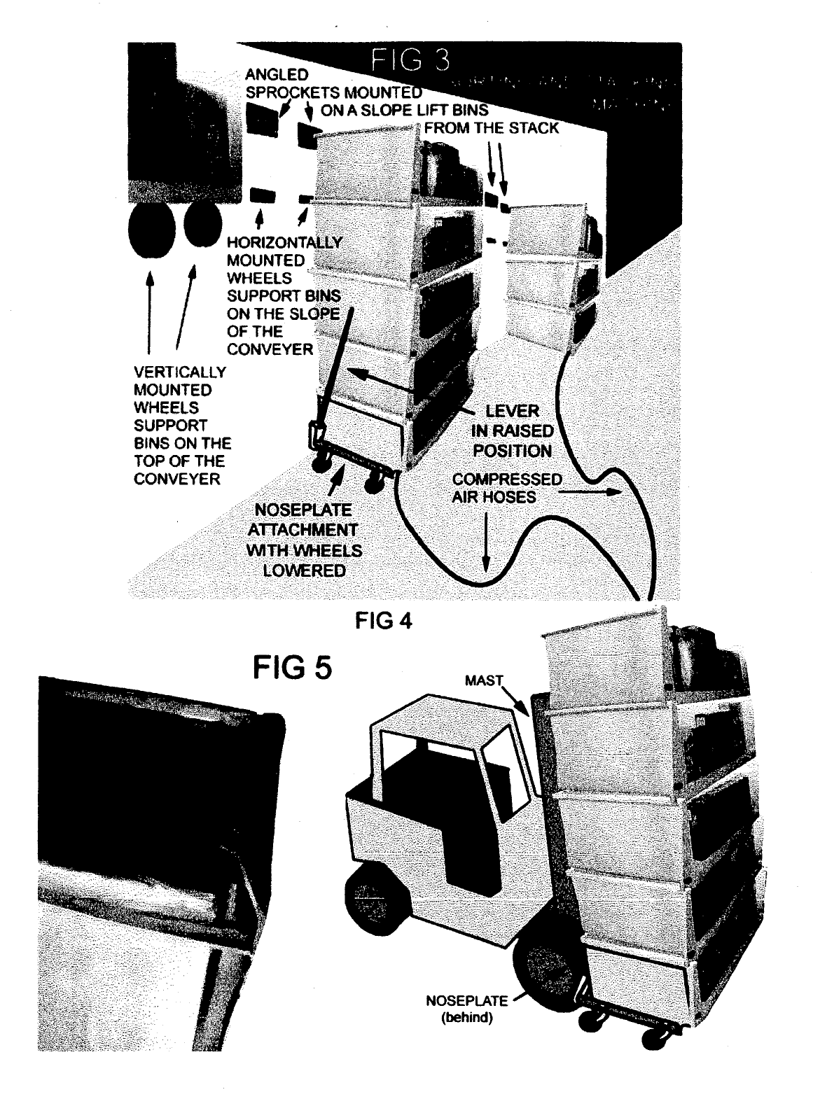

The present invention consists of a solid “U” shaped plate, preferably of metal or composite material. The corners should be rounded to prevent sharp object injuries (FIG. 1). The bottom front corners should be cut away so that an air hose can be attached to the compressed air fittings on the bin (FIG. 1, FIG. 5) with the present invention attached (FIG. 3). The top rear edge can be turned outward and curled downward to hang from the mast or nose plate of a fork lift truck with the forks removed (FIG. 4). The rear may be notched or perforated with additional methods of attachment peculiar to different models of fork lift trucks, cranes, and pallet jacks.

2. Wheels

Retractable wheels can be added to allow the present invention to be used as a stand alone cart when carrying a stack of bins (FIG. 1, FIG. 3). The wheels should castor so that the cart can move in different directions. They should be mounted to a shaft rotated by a lever so that the operator can lower the present invention and slide it under the back of a stack of bins with the castors tipped at an angle, then lift the bins by pulling on the levers to raise the castors to a vertical position. The levers should be attached to the shafts by inserting them into sleeves wide enough in the fore and aft direction to allow the levers to rock from front to rear when fully inserted so that after each end of the stack is lifted up, the lever can be positioned alongside the stack bins to hold the castors in a vertical position and also to prevent the lever from being snagged on obstacles as the bins are being moved. The levers should be removed by pulling them out of the sleeves when the present invention is attached to the mast or nose plate of a fork lift (FIG. 4).

3. Dimensions

The preferred dimensions of the present invention are 1 meter wide (outer dimension not including wheels) and 21 inches deep (inner dimension). The height should be 1 foot minus one half of the diameter of the wheels. The shape and angle of the sides should conform to the shape and angles of the sides of the bin.

What is claimed:

1. A “U” shaped device for lifting and transporting Stackable Open Front Grocery and Goods Bins having inner dimensions similar to the outer dimensions of the sides of the Bins and a height less than the height of the sides of the bins so that the top edge will fit under and support the curled outward top edges of the bins.

2. The device in claim 1 with wheels.

3. The wheels in claim 2 attached to a shaft equipped with a lever to raise and lower the wheels.

4. A wide sleeve holding the levers to the shaft in claim 3.
